(19) United States
(12) Patent Application Publication
(10) Pub. No.: US 2005/0088544 A1
(43) Pub. Date: Apr. 28, 2005

(54) Method of generating a composite output including a live image portion and an electronic map portion

(75) Inventor: Frank Wang, Taipei City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Eastern Broadcasting Co., Ltd., Taipei City (TW)

(21) Appl. No.: 10/826,940

(22) Filed: Apr. 16, 2004

(30) Foreign Application Priority Data
Oct. 23, 2003 (TW) 091124570

(51) Int. Cl. H04N 5/262

(52) U.S. Cl. 348/239

(57) ABSTRACT

A method of generating a composite output includes the steps of: a) capturing a live image; b) generating an electronic map; and c) generating a composite output including at least one of a live image portion corresponding to the live image captured in step a), and an electronic map portion corresponding to the electronic map generated in step b).

### BACKGROUND OF THE INVENTION

1. Field of the Invention

The invention relates to a method of generating a composite output, more particularly to a method of generating a composite output including a live image portion generated by a digital camera and an electronic map portion generated by a global position system (GPS) terminal.

2. Description of the Related Art

Live news coverage is prevalent nowadays to satisfy the demand for real-time information. Currently, live news coverage is accomplished using either microwave signal transmission or satellite news gathering (SNG). When employing SNG, a mobile transmitter unit transmits captured live audio and video information to a satellite for subsequent downloading to a ground station (such as a television broadcasting station), which is responsible for broadcasting the same.

News report programs rely upon SNG transmission in many instances, such as occurrence of a catastrophic event, live coverage of a meeting, live coverage of a natural calamity, etc., to satisfy the demand for real-time information.

While SNG transmission enables live coverage of an event, the actual location of the event is unavailable from the captured live video information transmitted by the mobile transmitter unit. For instance, in case of live coverage of a landslide that occurred in a mountainous region, viewers in the vicinity thereof have interest in knowing the exact location of the landslide in order to be able to take the necessary precautions.

Moreover, in the case of travel programs, which may be broadcast live through SNG transmission or pre-recorded for subsequent broadcast, introductory information for a scenic spot is somewhat lacking if the scenic spot is simply described without being accompanied by a map to indicate its location.

### SUMMARY OF THE INVENTION

Therefore, the object of the present invention is to provide a simple and low-cost method of generating a composite output that includes a live image portion and an electronic map portion in order to help ensure thoroughness of disseminated information.

According to the present invention, a method of generating a composite output comprises the steps of:
a) capturing a live image;
b) generating an electronic map; and
c) generating a composite output including at least one of a live image portion corresponding to the live image captured in step a) , and an electronic map portion corresponding to the electronic map generated in step b).

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram to illustrate a system for implementing the preferred embodiment of a method of generating a composite output according to the present invention;

FIG. 2 is a flow diagram to illustrate data flow in the method of the preferred embodiment;

FIG. 3 is a schematic view of a portable global position system (GPS) terminal used in the method of the preferred embodiment;

FIG. 4 is a schematic diagram to illustrate how a captured live image and a generated electronic map are combined in the method of the preferred embodiment; and

FIG. 5 is a schematic diagram to illustrate how broadcasting of the composite output can be accomplished in the method of the preferred embodiment.

### DETAILED DESCRIPTION OF THE PREFERRED EMBODIMENT

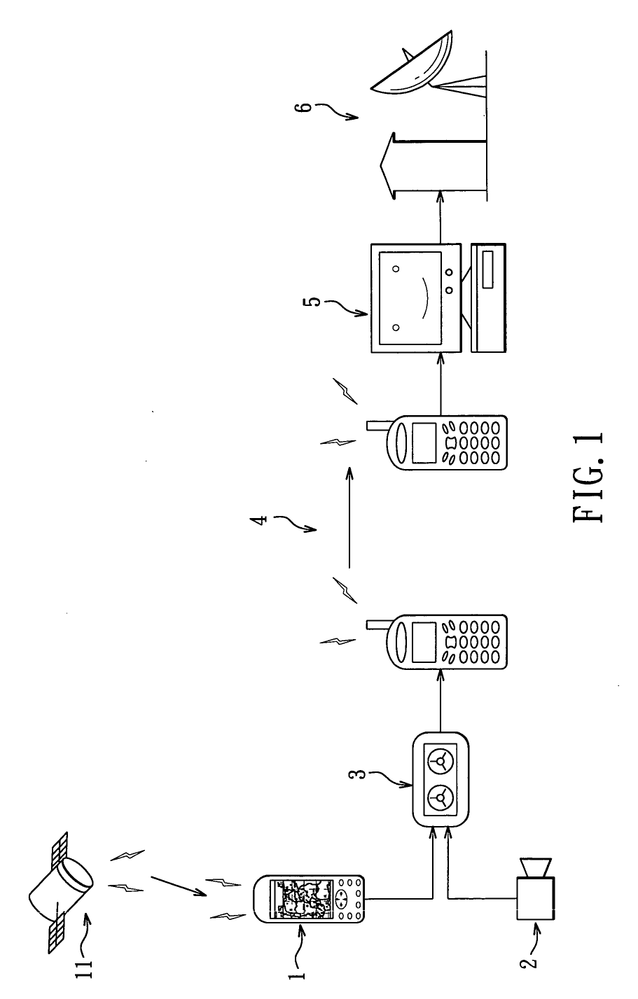

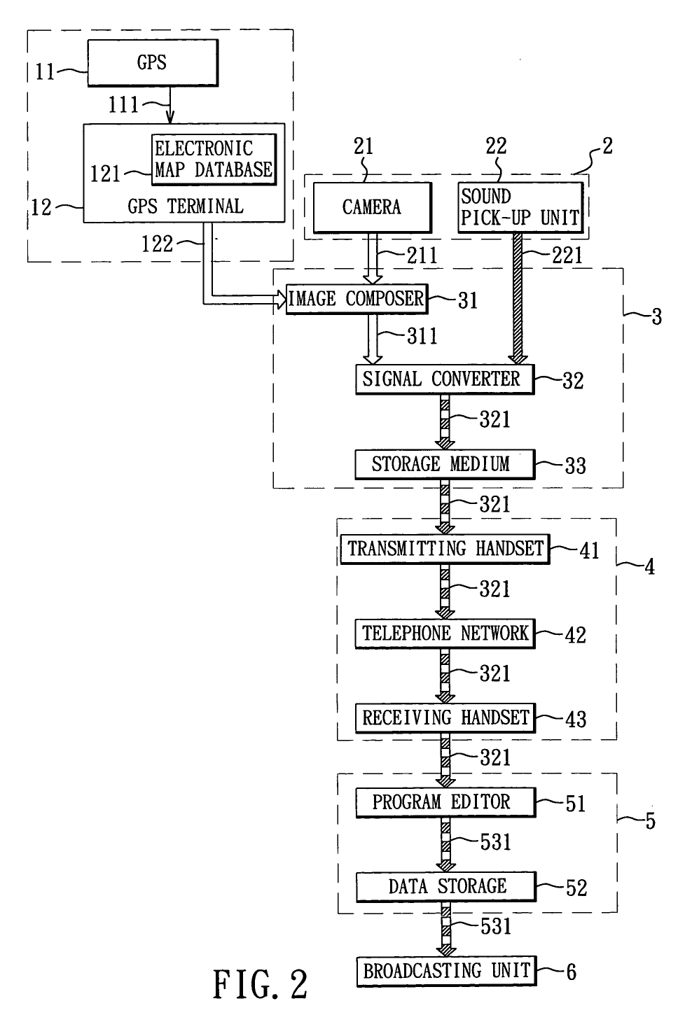

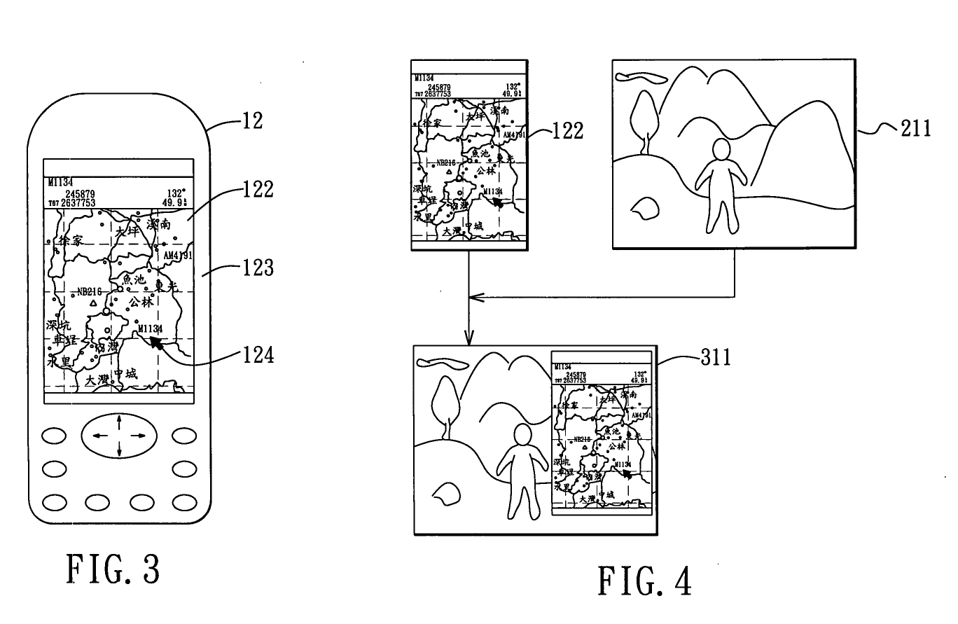

Referring to FIGS. 1 to 3, a system for implementing the preferred embodiment of a method of generating a composite output according to the present invention is shown to include a capturing unit 2, a map generator 1, a first editing unit 3, a transmission unit 4, a second editing unit 5, and a broadcasting unit 6. In this embodiment, the system is used to disseminate news information. In practice, this invention is also applicable to the dissemination of other types of information, such as introductory information for scenic spots, nature and environmental programs, etc.

In this embodiment, the capturing unit 2 includes a camera 21 (such as a digital camera) and a sound pick-up unit 22 (such as a microphone). The camera 21 is used to capture a live image. The sound pick-up unit 22 is used to pick-up a live audio (such as comments made by a reporter) associated with the live image.

The map generator 1 is used to generate an electronic map that indicates a location where the live image is being captured by the capturing unit 2. In this embodiment, the map generator 1 is a portable terminal 12 (hereinafter referred to as GPS terminal 12) that is capable of requesting position information 111 from a global position system (GPS) 11. The GPS terminal 12 has an electronic map database 121 stored therein. With reference to the position information 111 received from the GPS 11, the GPS terminal 12 searches the electronic map database 121, and generates an electronic map image 122 that is shown on a display screen 123 and that includes a pointer 124 to indicate the actual location on the electronic map image 122. In practice, the GPS terminal 12 may be in the form of a mobile telephone, a personal digital assistant or a vehicle accessory with the requisite GPS functionality. Since the specific construction of the GPS terminal 12 and its operation are well known in the art and are not pertinent to the present invention, a detailed description of the same will be omitted herein for the sake of brevity.

The first editing unit 3, which is preferably installed in a vehicle, receives data of the electronic map image 122 from the GPS terminal 12, and data of the captured live image 211 and the picked-up live audio 221 from the capturing unit 2. The first editing unit 3 can be configured to receive the various data via a wired or wireless communications channel, such as IEEE802.11x wireless communications protocol or Bluetooth protocol. The first editing unit 3 includes an image composer 31 capable of combining the electronic map image 122 with the captured live image 211. With reference to FIG. 4, the image composer 31 generates a composite image output 311 that includes at least one of a live image portion corresponding to the captured live image 211 and an electronic map portion corresponding to the electronic map image 122. It is noted herein that both the live image portion and the electronic map portion need not always be present in the composite image output 311 of the image composer 31. When the composite image output 311 includes both the live image portion and the electronic map portion, the image composer 31 superposes the electronic map portion on the live image portion (i.e., the live image portion is disposed at the background, whereas the electronic map portion is disposed at the foreground) using known image combining techniques, such as the chrome key technique. The ratio of the size of the electronic map portion to the live image portion can be varied through the control of the image composer 31 depending on actual requirements.

The first editing unit 3 further includes a signal converter 32 that receives the composite image output 311 from the image composer 31 and the picked-up live audio 221 from the capturing unit 2 in a wired or wireless manner. The signal converter 32 performs known encoding and compression operations upon the data received thereby to result in a composite output 321, which is in the form of a file that complies with the MPEG-4 data compression standard or with a multi-media file format directly applicable to a 3G mobile telephone handset.

The first editing unit 3 additionally includes a storage medium 33 for storing the composite output 321 therein.

In a preferred embodiment, the signal converter 32 and the storage medium 33 are implemented in the same portable computer, with the use of conventional image processing software and a hard disk of the computer. In another embodiment, the image composer 31, the signal converter 32 and the storage medium 33 are all implemented in the same computer.

It should be noted herein that the live audio portion is not necessarily present in the composite output 321 of the first editing unit 3 in some applications of the present invention.

In practice, the map generator 1, the capturing unit 2 and the first editing unit 3 are disposed in a first location (such as the news site), whereas the second editing unit 5 and the broadcasting unit 6 are disposed at a second location (such as a television broadcasting station) different from the first location. Hence, the transmission unit 4 is responsible for transmitting the composite output 321 stored in the storage medium 33 to the second editing unit 5.

In this embodiment, the transmission unit 4 includes a transmitting handset 41 and a receiving handset 43. The handsets 41, 43 comply with a communications framework (for instance, the 3G, W-CDMA or CDMA2000 standard), and are coupled to the first editing unit 3 and the second editing unit 5, respectively, in a wired or wireless manner. Therefore, the composite output 321 stored in the storage medium 33 of the first editing unit 3 is transmitted in a digital packet format from the transmitting handset 41 to the receiving handset 43 through a mobile telephone network 42 for subsequent reception by the second editing unit 5.

In practice, transmission of the composite output 321 from the first editing unit 3 to the second editing unit 5 may be conducted using a computer network, and should not be limited to transmission through the mobile telephone network 42.

Because the composite output 321 is transmitted to the second editing unit 5 in a compressed file format, the transmission time can be reduced while maintaining an acceptable level of picture quality.

In this embodiment, the second editing unit 5 includes a program editor 51 and a data storage 52. The second editing unit 5 can be implemented using a personal computer, or a server with large processing and storage capacity. The program editor 51 can be used to edit the composite output 321, such as through known non-linear editing techniques, and insert scrolling captions and other special effects into the composite output 321, thereby resulting in an edited output 531 that is subsequently stored in the data storage 52.

The editing procedure may be performed in an automated manner, or manually to enhance program quality. Moreover, the editing procedure may be omitted in some applications of this invention to meet the demand for real-time broadcasting.

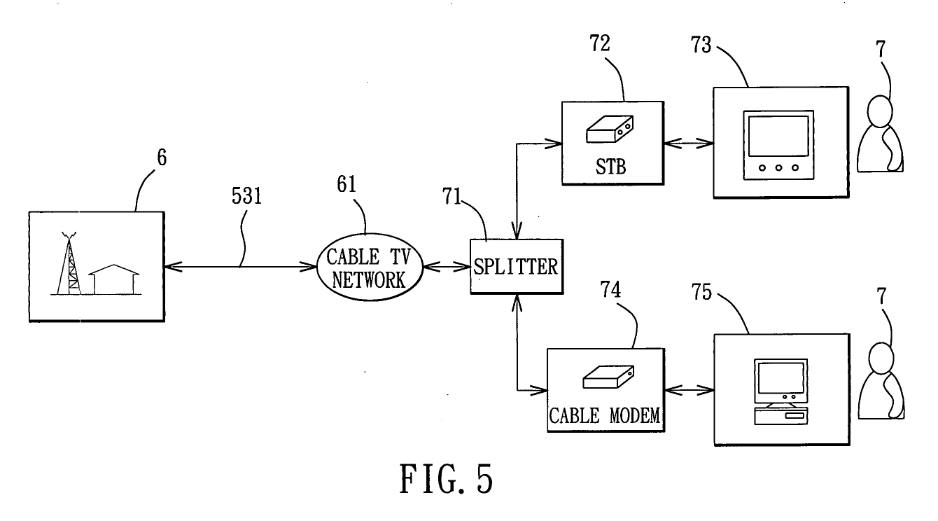

The broadcasting unit 6 is used to broadcast the edited output 531 stored in the data storage 52 to subscribers. As shown in FIG. 5, the broadcasting unit 6 may be a digital TV program system broadcasting platform for receiving the edited output 531 as one of several multi-media program contents available for selected viewing by subscribers 7 based on a multimedia-on-demand (MOD) service. The broadcasting unit 6 transmits the edited output 531 in a digital packet format to the subscribers 7 via a cable TV network 61. The cable TV signals are split by a splitter 71 into two portions: one of which is received by a set top box (STB) 72 for undergoing digital-to-analog conversion, decompression, and decryption prior to receipt by a subscriber terminal 73 (such as an analog television set); and the other one of which is received by a cable modem 74 for undergoing demodulation prior to receipt by another subscriber terminal 75 (such as a computer). In this embodiment, the broadcasting unit 6 further includes: a subscriber management system for managing subscriber's identification, authorization, fee-charging, access time period, etc.; a web page server system for providing subscribers with web pages for HTML browsing; and a data server system to store the edited output 531 and other audio-video data supplied by content providers.

It should be noted herein that there are many alternatives currently available for implementing the broadcasting unit 6. For example, the edited output 531 may be transmitted to subscribers 7 in analog or digital form through ADSL, conventional satellite microwave technology, wired transmission lines, or other wireless transmission techniques. Moreover, the broadcasting unit 6 should not be limited to a television broadcasting system platform as other alternatives, such as the Internet, mobile phone handset, PDA or other content providing server platforms that operate in conjunction with conventional network communication systems and electronic equipment interfaces, etc., are available.

In addition, as described in the foregoing, this invention is not limited for use by a television studio for the production of television programs. For instance, the invention can be applied to generate a composite output for viewing by friends and relatives of participants in a tour group to an exotic location.

It has thus been shown that, with the inclusion of both a live image portion and an electronic map portion in the composite output generated according to the method of this invention, the thoroughness of the disseminated information can be ensured. Moreover, since data transmission between the first and second editing units 3, 5 can be accomplished using 3G handsets, the costs for implementing the method of this invention is relatively small as compared to that incurred using conventional SNG transmission equipment.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method of generating a composite output, comprising the steps of:
a) capturing a live image;
b) generating an electronic map; and
c) generating a composite output including at least one of a live image portion corresponding to the live image captured in step a), and an electronic map portion corresponding to the electronic map generated in step b).

2. The method as claimed in claim 1, wherein the live image is captured using a digital camera in step a).

3. The method as claimed in claim 1, wherein the electronic map generated in step b) indicates a location where the live image is being captured in step a).

4. The method as claimed in claim 3, wherein the electronic map is generated using a global position system (GPS) terminal in step b).

5. The method as claimed in claim 1, wherein the composite output includes both the live image portion and the electronic map portion which is superposed on the live image portion.

6. The method as claimed in claim 1, further comprising the step of:
d) broadcasting the composite output.

7. The method as claimed in claim 6, wherein steps a) b) and c) are performed in a first location.

8. The method as claimed in claim 7, wherein step d) is performed in a second location different from the first location, said method further comprising, between steps c) and d):
e) transmitting the composite output to the second location.

9. The method as claimed in claim 8, wherein, in step e), the composite output is transmitted to the second location through a network.

10. The method as claimed in claim 9, wherein the network is a telephone network.

11. The method as claimed in claim 9, wherein the network is a computer network.

12. The method as claimed in claim 8, wherein, in step e), the composite output is transmitted to the second location in a compressed file format.

13. The method as claimed in claim 8, wherein step d) includes:
editing the composite output to generate an edited output; and
broadcasting the edited output to a subscriber.

14. The method as claimed in claim 1, further comprising the step of:
d) picking-up a live audio associated with the live image;
the composite output further including a live audio portion corresponding to the live audio picked up in step d).

15. The method as claimed in claim 14, further comprising the step of:
e) broadcasting the composite output.

16. The method as claimed in claim 15, wherein steps a), b), c) and d) are performed in a first location.

17. The method as claimed in claim 16, wherein step e) is performed in a second location different from the first location, said method further comprising, between steps c) and e):
f) transmitting the composite output to the second location.

18. The method as claimed in claim 17, wherein, in step f), the composite output is transmitted to the second location through a network.

19. The method as claimed in claim 17, wherein, in step f), the composite output is transmitted to the second location in a compressed file format.

20. The method as claimed in claim 17, wherein step e) includes:
editing the composite output to generate an edited output; and
broadcasting the edited output to a subscriber.
